(19) United States
(12) Patent Application Publication
(10) Pub. No.: US 2022/0347034 A1
(43) Pub. Date: Nov. 3, 2022

(54) MOURNER'S PARTICIPATION COFFIN

(71) Applicant: Hermanus Stephanus PRETORIUS, Kempton Park (ZA)

(72) Inventor: Hermanus Stephanus PRETORIUS, Kempton Park (ZA)

(21) Appl. No.: 17/761,087

(22) PCT Filed: Sep. 18, 2019
(86) PCT No.: PCT/ZA2019/050059

§ 371 Date: Mar. 16, 2022

(51) Int. Cl. A61G 17/04

(52) U.S. Cl. CPC A61G 17/04

(57) ABSTRACT

A coffin arrangement comprises a single or double layered panel material, the exterior having removable participation indicia modules nested inside debossed shapes on each side of the coffin, being the lid, the sides, and the end panels. Indicia Modules may be removed from the coffin before, during or after a funeral service so that family and friends can share their “final words” by placing indicia on the indicia modules. The indicia modules may be placed back to their original position via a numeric control system on the coffin and the indicia modules. The modules may be fastened to the coffin by mechanical and non-mechanical means including friction fit or the likes. Indicia modules may be removed and kept as memorabilia before, during or after the service.

### FIELD OF INVENTION

The invention relates to a coffin manufactured for the purpose of burial and the purpose of mourner's participation before, during or after a funeral service, having participation indicia modules.

The invention relates to a coffin manufactured from a single layer panel material, there are provided by means of router cutting, or other technology alike, debossed sections of any shape and size of any planer surface of the outer coffin surface. The de-bossed sections to have the nesting participation “final words” indicia modules of family and friends to be used before, during or after a funeral service.

The invention relates to a coffin arrangement manufactured with more than one layered panels, whereby the outer layer is partly cut into modules that are removable before, during or after a funeral service by either attending the service, or using an online “final words app” from remote places in the world to participate.

The “Final Words” indicia modules containing mourner's final written messages are then to be placed back to its original position out the outer coffin surface before, during or after the service.

### BACKGROUND OF THE INVENTION

The applicant is aware that when attending a funeral service there is very little opportunity to participate in the actual proceedings. At a funeral service itself it is usually only the priest and a family member who would speak and lead the proceedings. As a sign of last respect family and friends would normally place flowers on the coffin or in the grave because there is no other provided means of participating.

In some cases, and more so in instances of cremation, the family and friends don't have any opportunity to pay their last respect other than attending the funeral.

In other instances, family and friends from faraway places who are unable to attend the funeral service have no opportunity to pay their last respects or to participate in the proceedings.

The applicant, having analysed the above shortcoming and needs, proposes the invention hereunder whereby a user can remove a module that forms an integral part of the coffin construction, from the coffin before, during or after the service, define a “Final Words” indicia onto the said module in their own comfort and privacy and in their own time before, during or after the service and then attach the module back onto the coffin before, during or after the service, Thus giving the user the opportunity to participate in the service by sharing their “Final Words” on an actual section of the coffin.

Family and friends who are unable to attend the funeral service in person can send an online “Final Words” message via the Final Words App that could be written, printed, engraved or lasered onto the Final Words module.

Before burial the family has the option to remove all modules containing indicia from the coffin to be kept as memorabilia.

It can thus be seen that the present invention provides a novel coffin that allows family and friends of the deceased the opportunity to participate in the funeral proceedings before, during or after the funeral in their own comfort and time.

The invention described herein have several aspects, each of which addresses one or more of the problems or shortcomings not specifically mentioned, but which will become readily apparent to those of ordinary skill in the art by reference of the following detailed description and accompanying drawings.

### BRIEF SUMMARY OF THE INVENTION

According to the first aspect of the invention there is provided a coffin which includes:

At least one outer surface;

The outer surface being defined by a plurality of interconnected modules;

The polarity of modules being shaped and sized to define said outer surface when interconnected;

Wherein the modules are further configured to allow a user to define “final words” indicia thereon before, during or after the funeral service;

The de-bossed or pre-cut surface may be of any shape or size;

The modules may include a numerical value which corresponds with a numerical value on the de-bossed or pre-cut surface of the coffin arrangement;

The modules may include at least one surface having a participation indicium receiving portion;

The indicia may include words, letters, numerals and/or signage and may be hand-written, printed, engraved or laser cut onto the module.

According to a second aspect of the invention there is provided a coffin arrangement which includes:

At least one indicia surface for allowing a user to define a participation indicium on said indicia surface, which includes;

A pre-cut outer surface frame bonded to the coffin arrangement to form de-bossed areas;

And a plurality of modules which define participation indicia surface when arranged in a side by side manner inside the de-bossed areas;

A plurality of pre-cut frame elements may be provided, said framing extending circumferentially around each module when arranged inside the main frame and a polarity of modules which define participation indicia surface when placed inside the frames;

The modules may further include one surface which is configured to allow a user to define participation indicia before, during or after a funeral service;

Indicia may include words, letters, numerals and/or signage and may be hand-written, printed, engraved or laser cut onto the module;

An online message system called “Final Words” is provided to accommodate for family and friends that are not able to attend the service. The user will have the option of selecting a specific module on the coffin for indicia (similar to booking a seat on an aeroplane) The user may submit a “Final Words” message and said indicia may or may not be placed on the selected module by a third party, this may be done by way of words, letters, numerals and/or signage and may be hand-written, printed, engraved or laser cut onto the module and the module to be placed back into its original position on the coffin arrangement before, during or after the service;

The coffin and the indicia modules may further include an additional de-bossing or recess within the de-bossed section or on the rear of the indicia modules to provide for mechanical or non-mechanical form of adhesive;

The coffin and the indicia module may further include an additional de-bossing or recess within the de-bossed section or on the rear of the indicia module to make provision for a pen, permanent marker or alike that is used to write final indicia onto the indicia module before, during or after a funeral service.

The above described features and advantages, as well as others, will become more readily apparent to those of ordinary skill in the art by reference to the following detailed description and accompanied drawings.

### BRIEF DESCRIPTION OF THE DRAWINGS

FIG. 1 shows a perspective view of an exemplary embodiment of an indicia surfaced coffin

FIG. 2 shows an exploded perspective view of multiple indicia modules with indicia surfaces on the outer surface of the coffin arrangement

FIG. 3 shows a perspective view of a double layered corrugated cardboard coffin with window frames that are die-cut on the lid and side panels on the outer panel of the casket to form de-bossed shapes. The cut our sections that were removed to form the de-bossing now forms the indicia modules used for participation indicia.

FIG. 4 shows a perspective view of a dome shaped casket with indicia modules

FIG. 5 shows a perspective view of two corrugated cardboard coffins, one with removed indicia modules and the other with indicia modules placed back after participation

### DETAILED DESCRIPTION

With reference to the principles of the innovative embodiments, written description would be made with reference to the drawings below;

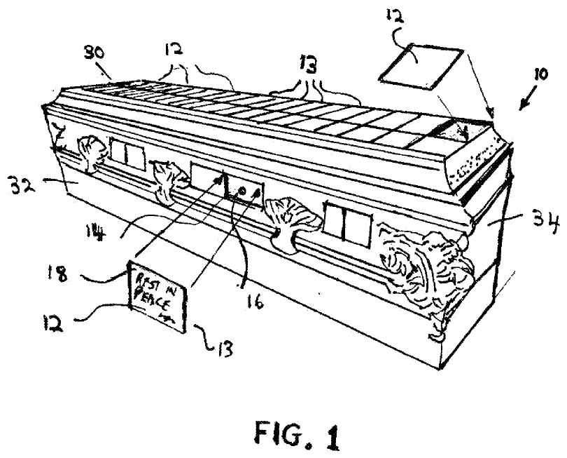

FIG. 1 shows an indicia module included coffin arrangement (10) that includes features of the present invention;

At least one or multiple modules (13) with indicia surface (12) for allowing a user to define indicia before, during or after the service on the said indicia surface (12) and place the module (13) back to its original position on the coffin arrangement

The indicia (18) may include words, letters, numbers or signage and may be added by way of hand-written indicia, printed, engraved, laser cut or other acceptable means.

The multiple indicia modules (13) may be cut from the outer layer of the coffin (10) when the coffin panels are manufactured by more than one layer and may be cut on any of the side, end or top panels, or all simultaneously.

A removed indicia module (13) leaves a de-bossed frame (14) on the coffin arrangement (10) and once the indicia(18) has been added to the indicia surface (12) and placed back to its original position(14) a flush surface appearance is achieved to that of a traditional coffin.

Within the de-bossed section (14) on the coffin arrangement (10) there is provided a further recess (16) to make provision of any mechanical or non-mechanical fastener. EXAMPLE—an additional recess (16) may contain a magnet that is flush with the level of the de-bossed area (14) once placed into the recess (16) to ensure that the magnet, or any other form of fastener or adhesive, does not protrude.

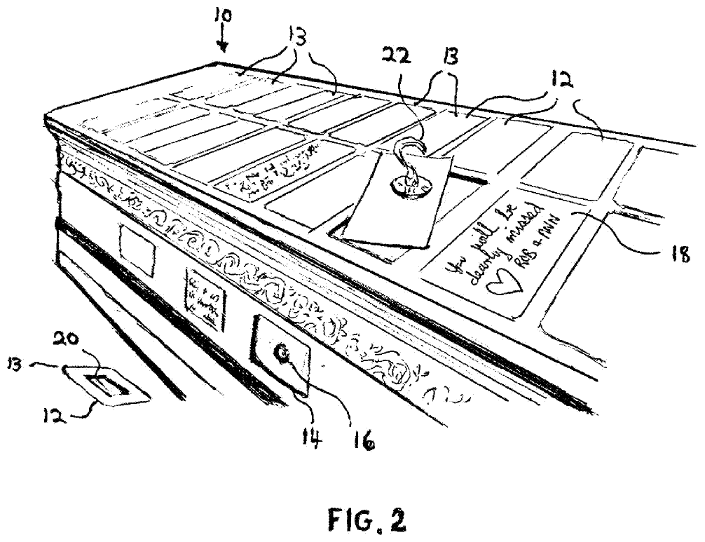

FIG. 2 shows an exploded perspective view of the coffin arrangement (10) with some indicia modules untouched, one partly removed, and one totally removed showing the recessed area (20) to make provision for any form of fastening, mechanical or non-mechanical. EXAMPLE—a steel plate may be placed within the recessed area (20) that forms a flush surface once inserted and glued inside the recessed area. Because of the steel plate not protruding it will allow the indicia module to give a flushed exterior surface to the coffin (10) once placed in its original position.

FIG. 2 further shows some indicia modules (13) with indicia added to the indicia surface (18) placed back to its original position on the coffin arrangement (10)

Indicia Modules (13) may be removed from the coffin arrangement (10) before, during or after the service by way of mechanical or non-mechanical tools. EXAMPLE—in the event that the indicia models were held to the coffin by way of a magnet based in the recess provided within the de-bossed shape (16) and a steel plate based in the recess provided on the back of the indicia module (20) then the indicia module may be removed from the coffin by way of using a stronger magnet (22) than the one holding the indicia module in place. Other mechanical and non-mechanical tools may also be used such as a suction cup.

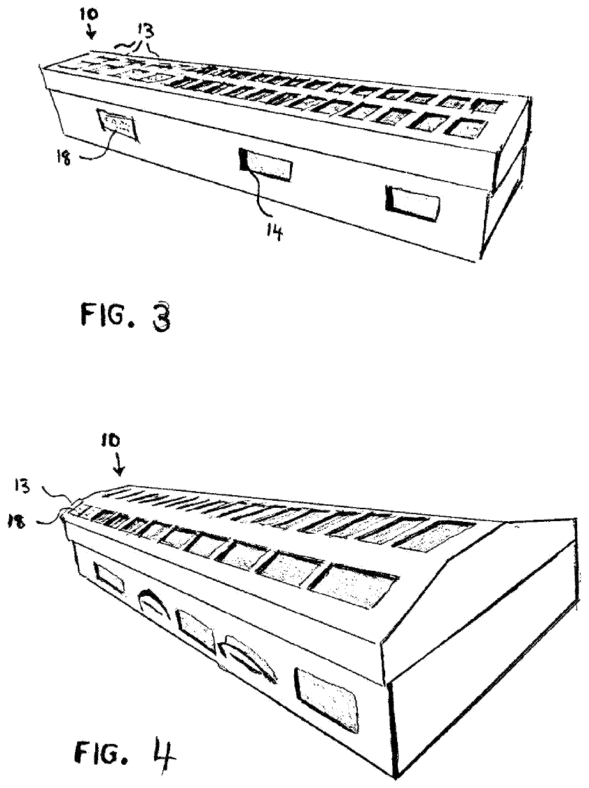

FIG. 3 shows a perspective view of a coffin arrangement (10) manufactured from double layered cardboard. The outer layer of the cardboard coffin arrangement (10) has di-cut shapes on the lid and/or side panels and/or end panels forming de-bossed shapes (14). The shapes that have been cut from the outer layer will form the indicia modules (13). Said Indicia modules may be held to the de-bossed area by way of friction fit or other mechanical or non-mechanical adhesive. EXPAMLE—a thin layer of glue or double-sided tape may be used to hold each indicia module in place.

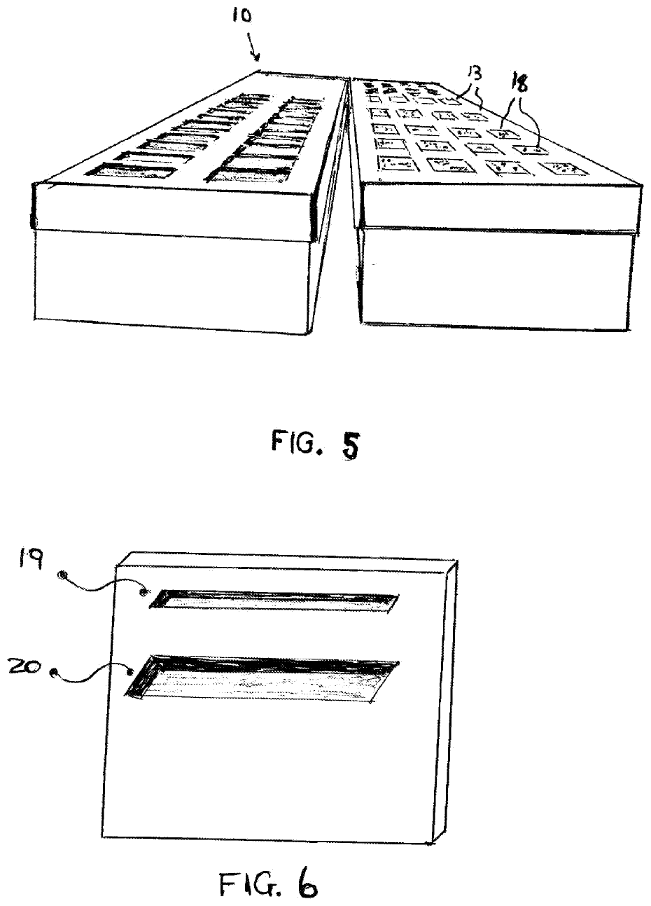

FIG. 4 shows a perspective view of a coffin arrangement (10) that is manufactured from a double layer corrugated cardboard and has a dome shaped lid. Participation Indicia modules cover the outer layer of the coffin arrangement (10) on the side panels, end panels and lid.

FIG. 5 shows a perspective view of two double layered corrugated cardboard coffins, one with removed indicia modules and the other with indicia modules placed back in their original position after participation before, during or after the funeral service.

FIG. 6 shows a perspective view of indicia module containing additional recess on the rear (19) that makes provision to hold or store a pen that is used to write indicia on the indicia module before, during or after the service

1. A coffin manufactured for the purpose of participation by mourners, with a complete exterior appearance comprising means of allowing mourners to participate in a funeral service by defining indicia directly to a plurality of removable indicia modules and returning said indicia modules to its original position on the coffin before, during or after the funeral service;

2. A coffin according to claim 1 comprising one or more de-bossed shapes containing removable indicia modules

3. A coffin according to claim 1 wherein any exterior surface such as side panels, end panels and lid panels contain de-bossed shapes with removable indicia modules

4. A coffin according to claim 1 where one or all panels are manufactured by a laminate of 2 or more panels of which the outer panel has shapes cut from the panel before laminated to the inner panel to form a completed panel with de-bossed shapes

5. A coffin according to claim 1 manufactured from wood, steel, hardboard, cardboard, artificial wood, plastic or any other suitable material or process including, but not limited to injection moulding

6. A coffin according to claim 1 containing indicia Modules for the purpose of mourner's participation before, during or after a funeral service

7. A coffin according to claim 6 containing Indicia modules of any number, size or shape

8. A coffin according to claim 6 containing Indicia Modules where the Indicia Module is thinner than the depth of the de-bossed area to make provision for mechanical or non mechanical means of attachment

9. A coffin according to claim 6 containing indicia modules with a recess on the rear of the module to make provision for any mechanical or non-mechanical means of attachment to a coffin

10. A coffin according to claim 6 where indicia modules have an additional recess to hold or store a pen that is used to write indicia on the indicia module before, during or after the funeral service

11. A coffin according to claim 1 where a recess within the de-bossed sections makes provision for any mechanical or non-mechanical means of attaching a indicia module to the coffin

12. A coffin according to claims 1 where an additional recess within the de-bossed sections makes provision to hold or store a pen that is used to write indicia onto the indicia module before, during or after the funeral service

13. A coffin according to claim 1 where the coffin appears complete once all indicia modules are attached to the coffin and incomplete when removed before, during or after the funeral service

14. A coffin according to claim 1 where the indicia modules are marked with identification marks corresponding to identification marks within the de-bossed areas

15. A coffin according to claim 1 where all indicia modules may be removed and kept as memorabilia

16. A coffin according to claim 1 where indicia may be received via any online messaging service and placed on the indicia surface by a third party before, during or after a service
